(19) United States
(12) Patent Application Publication
(10) Pub. No.: US 2010/0176650 A1
(43) Pub. Date: Jul. 15, 2010

(54) METHOD OF ATTACHING WHEEL OVERLAYS

(75) Inventors: Timothy J. Zens, Grosse Pointe Park, MI (US); Rajat K. Agarwal, Duesseldorf (DE); James E. Thompson, Plymouth, MI (US); Gregory A. Ferguson, Harrison Township, MI (US); Scott J. Beleck, Harrison Township, MI (US); David Inkpen, Rochester, MI (US)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/635,507

(22) Filed: Dec. 10, 2009

Related U.S. Application Data
(63) Continuation of application No. PCT/US2008/007831, filed on Jun. 24, 2008.

(51) Int. Cl. B60B 19/00; B60B 7/00; B32B 37/00; B32B 38/10; B32B 38/00

(52) U.S. Cl. 301/5.1; 301/37.101; 301/37.42; 156/60; 156/247; 156/307.1

(57) ABSTRACT

A decorative overlay comprised of thin plastic or metal may be securely fastened to a wheel using one or more preformed, solid, dimensionally stable, heat-activatable adhesive bodies. The use of such adhesive bodies offers significant processing and performance advantages over conventional methods for cladding wheels.

This application is a continuation under 35 U.S.C. Sections 365(c) and 120 of International Application No. PCT/US2008/007831, filed Jun. 24, 2008 and published on Dec. 31, 2008 as WO 2008/002487, which claims priority from U.S. Provisional Patent Application Ser. No. 60/945,981 filed Jun. 25, 2007, which are incorporated herein by reference in their entirety.

### FIELD OF THE INVENTION

The invention relates to improved methods for assembling vehicle wheels having decorative and/or protective claddings, where an overlay is attached to a wheel using an adhesive.

### DISCUSSION OF THE RELATED ART

One method currently employed for manufacturing vehicle wheels involves attaching a relatively thin decorative and/or protective overlay (sometimes referred to as a “cladding”) comprised of plastic, chrome-plated plastic, stainless steel or the like to a functional wheel which is constructed of steel, aluminum alloy or other such metal. The overlay provides an attractive, durable finish to the wheel, generally at a lower overall cost than an alloy wheel having an exposed surface that has to be specially finished in multiple steps to provide comparable appearance and performance. Clad wheels are also preferred over wheels having non-permanently attached wheel covers which are secured to the wheel by retention clips or the like, but which can be readily detached from the wheel if the vehicle hits a pothole or other obstacle in the road or by a thief.

Many different wheel cladding methods have already been proposed, including the techniques described in the following U.S. Pat. Nos.: 3,669,501; 3,915,502; 4,416,926; 5,368,370; 5,564,791; 5,577,809; 5,597,213; 5,630,654; 5,636,906; 5,845,973; 6,082,829; 6,346,159; 6,547,341; 6,637,832; 6,729,695; 6,755,485; 6,779,852; 6,932,435; 6,991,299; 6,998,001; 6,955,405; 7,025,426; 7,025,844; 7,097,730; 7,204,562; and 7,044,524. Other methods are described in WO 2007/092201 and WO 2007/098157, each incorporated herein by reference in its entirety.

Currently utilized methods for bonding overlays to wheels generally use one of three different types of adhesive systems: beads of one component adhesives, beads of two component adhesives, and two component polyurethane foams injected behind the overlay (cladding). In each case, the adhesive is applied in the form of a flowable liquid material. The adhesives applied as beads are effective at bonding the overlay, but tend to exhibit very poor acoustic properties (e.g., it is clearly evident from the sound characteristics of the clad wheel that the overlay is a thin covering simply glued to the wheel). The two component polyurethane foams injected between the cladding and the wheel not only provide effective bonding but also improved acoustic performance as compared to the adhesives applied as beads. However, the utilization of such foams has the disadvantage that the wheel assembly operation will require a foaming and fixturing system for each wheel/cladding combination, which is a significant capital investment. In addition, such polyurethane foam systems are messy and require special safety precautions to protect workers from the isocyanate-containing components that must be used.

It is therefore clear that the development of alternative, improved wheel cladding methods is still needed.

### BRIEF SUMMARY OF THE INVENTION

The present invention provides a method for attaching an overlay to a wheel. The method comprises the steps of:
a). providing a wheel having an outboard surface;
b). providing an overlay having an inboard surface;
c). applying at least one preformed, solid, dimensionally stable, heat-activatable adhesive body to at least one of the outboard surface of the wheel or the inboard surface of the overlay;
d). positioning the wheel and the overlay so that the outboard surface of the wheel faces the inboard surface of the overlay; and
e). heating the at least one adhesive body to a temperature effective to cause said at least one adhesive body to join the wheel and the overlay.

This method provides a means to effectively bond and seal the area between the cladding and the wheel, without the need for specialized, costly fixtures and without having to deal with the mess that can be created utilizing conventional wheel cladding adhesives that are applied as flowable liquids. This approach has the further significant advantages of providing acoustic performance that is enhanced as compared to the bead-applied adhesives and facilitating the changeover during a manufacturing operation from one type of wheel/cladding combination to another.

### DETAILED DESCRIPTION OF CERTAIN EMBODIMENTS OF THE INVENTION

The present invention utilizes one or more preformed, solid, dimensionally stable, heat-activatable adhesive bodies to secure together the outboard surface of the wheel and the inboard surface of the overlay, thereby attaching the overlay to the wheel in a permanent manner. The term “preformed” means that the adhesive body has been formed into the desired shape before being applied to the outboard surface of the wheel or the inboard surface of the overlay. Preferably, the adhesive body is unsupported; that is, it is not supported by or attached to any type of carrier or other structure prior to being positioned between the wheel and the overlay. The desired shape will vary depending upon the particular application. For example, the width and length of the adhesive body will be selected based upon the extent to which it is desired to cover the surfaces of the outboard surface of the wheel and the inboard surface of the overlay once the adhesive body has been activated by heating. The dimensions and overall shape of the adhesive body will also generally be selected to avoid having any adhesive visible to an observer looking at the outboard surface of the overlay once the wheel and overlay have been assembled. For example, if the overlay and wheel have holes or openings in them that are aligned in the assembled wheel, the adhesive body should be configured and positioned to avoid having any of the adhesive body extend into such openings. Typically, the thickness of the adhesive body is sufficient to permit essentially the entire gap between the overlay and the wheel to be filled with adhesive once the adhesive body has been activated by heating, thereby providing a secure adhesive bond between these components and also providing good acoustic properties. As will be explained further in more detail, filling of the gap may also be facilitated by the use of a heat-expandable (foamable) adhesive body. The adhesive body may be uniform in thickness (e.g., 0.5 to 20 mm thick) or may contain portions of varying thickness. In certain embodiments, the adhesive body is relatively thin; e.g., the thickest dimension may be less than 30% or less than 20% or less than 10% of the width or length of the adhesive body at its narrowest or shortest point. The adhesive body may be continuous in structure or may contain one or more through holes. The through holes may be configured to align with openings in the wheel or overlay when the adhesive body is applied to the wheel or overlay, for example. The adhesive body may be planar (flat) or curved or otherwise configured to match the contours of the wheel or overlay surface to which it is applied. In one embodiment, the adhesive body may initially be planar but is sufficiently flexible (either at room temperature or a moderately elevated temperature, e.g., up to about 50 degrees C.) to permit it to be conformed closely to the contours of the wheel or overlay surface. The overall shape of the adhesive body is varied as may be needed for a particular application; the adhesive body may, for example, be in the form of a circle, rectangular, square, triangle, ring, cross, oval, or other geometric shape or may be irregular in shape. In other embodiments, the adhesive body may be elongated with a relatively small cross-sectional area; e.g., the adhesive body may be in the form of a rod having a substantially circular cross-section or a cross-section which is partially curved and flat on one side or a substantially square or rectangular cross-section. The elongated adhesive body may be formulated to be sufficiently flexible at room temperature or a moderately elevated temperature to permit it to be readily bent, curved or otherwise shaped into the desired configuration when applied to the overlay or wheel. For example, the adhesive body may be a flexible rod approximately 0.5 to 10 mm in diameter.

The edges of the adhesive body may be of any suitable shape such as, for example, straight, rounded, chamfered, tapered, angled, notched or the like.

A single adhesive body or a plurality of adhesive bodies having the same shape or different shapes may be used to join a wheel to an overlay. Where a plurality of adhesive bodies is employed, the adhesive bodies may be positioned adjacent to each other and/or spaced apart from each other.

The adhesive body should be solid (i.e., not a liquid, gel or paste) and dimensionally stable, meaning that it does not flow or change in shape at room temperature (15 to 25 degrees C.) in the absence of any forces other than gravity and maintains its dimensions under such conditions. Preferably, the adhesive body does not readily distort when subjected to manipulation by hand, although some flexibility may be desirable where the adhesive body is to be conformed to a surface having a contour different from that of the surface of the adhesive body. Such characteristics facilitate the fabrication, storage, handling and application of the adhesive body and thus help avoid some of the problems associated with the adhesives conventionally used in wheel cladding manufacture. In one embodiment of the invention, all the outer surfaces of the adhesive body are non-tacky at room temperature. In other embodiments, however, one or more outer surfaces of the adhesive body are tacky at room temperature. A tacky surface may be utilized to position and attach the adhesive body where desired on the wheel or overlay surface, but such tacky surface may need to be temporarily protected by a release film, release paper or the like to avoid contamination of the surface with dirt or dust and/or to facilitate processing, storage, and handling. The release film or release paper is removed from the tacky surface prior to applying the adhesive body to the wheel or overlay. In one embodiment of the invention, only the surface to be applied to the overlay or wheel surface is tacky, with the other surfaces being non-tacky. A layer of a pressure sensitive adhesive or the like may be applied to the surface of an otherwise non-tacky surface to render it tacky, if so desired. Alternatively, an adhesive body having surfaces that are initially all tacky may be treated to render only certain of such surfaces or only certain portions of a surface non-tacky, through the application of an anti-blocking substance or the like. In yet another embodiment, all surfaces of the adhesive body are non-tacky and the adhesive body is held in the desired position and orientation relative to the overlay and/or wheel by mechanical means such as a clip, pin or bracket.

The adhesive body is also heat-activatable, meaning that the adhesive bond between the wheel and the overlay is created or enhanced when heat is applied to the adhesive body. In one embodiment, the adhesive body softens and flows when heated, thereby filling a space between the outer surface of the adhesive body and the other component of the wheel assembly (e.g., either the inboard surface of the overlay where the adhesive body has initially been applied to the outboard surface of the wheel or the outboard surface of the wheel where the adhesive body has initially been applied to the inboard surface of the overlay). Even where a surface of the adhesive body is initially in at least partial contact with a wheel or overlay surface when the wheel and the overlay are positioned so that the outboard surface of the wheel faces the inboard surface of the overlay, the adhesive bond between such surfaces is often significantly enhanced by the softening and flowing of the adhesive body whereby more intimate contact between the adhesive body and the wheel or overlay surface, with the adhesive body surface remaining adhered to the other surface when the adhesive body is subsequently cooled to room temperature (the adhesive body thus, in a sense, functions as a hot melt adhesive). In a particularly preferred embodiment of the invention, the adhesive body is at least in part expandable, that is, capable of being expanded when heated. Such heat-activated expansion may be effected through the use of one or more latent chemical and/or physical blowing agents, for example, which are stable at room temperature but release gas (by chemical decomposition, for example) or otherwise induce expansion (by expansion of hollow thermoplastic microspheres, for example) when heated to an elevated temperature. Sufficient blowing agent may be utilized to cause the adhesive body to expand at least 10% or at least 20% or at least 50% or at least 100% or at least 250% or at least 500% or at least 1000% or more in volume. In still another embodiment of the invention, the adhesive body may contain one or more latent curing agents (which may also be referred to as crosslinking agents) that induce curing and/or crosslinking of one or more components (e.g., polymers and/or polymer precursors) present in the adhesive body. Such latent curing agents (which are generally stable at room temperature) thus may render an initially thermoplastic material used to fabricate the adhesive body at least partially thermoset (crosslinked) in character after activation and thus more heat resistant (other properties of the adhesive body, such as its sound or vibration dampening properties, may similarly be manipulated or altered as desired through the use of such heat-activated curing agents).

The adhesive body may be uniform in composition, that is, formed of a single material (it being understood that such material may itself be an admixture of two or more components, such as one or more polymers (e.g., a thermoplastic such as a polyolefin or a copolymer of an olefin with one or more other types of monomers), one or more polymer precursors (e.g., an epoxy resin or other functionalized monomer, oligomer or prepolymer capable of forming a polymer when reacted), one or more fillers, one or more curing agents (especially latent curing agents), one or more blowing agents (especially latent blowing agents), one or more plasticizers, one or more pigments, one or more tackifiers and/or one or more stabilizers or a plurality of different materials. For example, the adhesive body may be laminar and contain two or more layers having different compositions and properties. For example, the adhesive body may have a core layer having one composition with an additional outer layer on either side, with the outer layers having the same or different compositions as each other. One layer, for example, may be rubbery or elastomeric in character, with another layer being a more rigid thermoplastic or thermosettable material. In another embodiment, at least one layer is expandable with at least one layer being non-expandable. In still another embodiment, different regions of the adhesive body may be comprised of different materials (e.g., a first material may be in a ring around the perimeter of the adhesive body, with a second material being present within the ring defined by the first material). The adhesive body may be formulated to contain components capable of being cured or crosslinked through exposure to radiation such as ultraviolet light or electron beam radiation, with the adhesive body (or certain sections or areas of the adhesive body) being irradiated so as to impart certain desired characteristics to the adhesive body.

Heat activation of the adhesive body may be selected to occur at any desired temperature through the choice of the components used to formulate the adhesive, e.g., the polymers, polymer precursors, blowing agents, curing agents and the like. Typically, the components of the formulation are chosen so that the adhesive body is heat-activatable at a temperature of at least 50° C. or at least 100° C. but not more than 250° C. or not more than 200° C.

Heating of the adhesive body may be accomplished by any suitable means such as, for example, baking in an oven (e.g., a paint cure oven) or induction heating. Continuous as well as batch heating processes may be employed. If the activation temperature of the adhesive body is the same as or greater than the temperature at which the overlay would begin to exhibit heat-related damage (distortion or discoloration, for example), the wheel may be pre-heated in the absence of any adhesive bodies to a temperature greater than (e.g., at least about 10 degrees C. or at least about 20 degrees C. greater than, but preferably not more than about 50 degrees C. or at least about 60 degrees greater than) the activation temperature of the adhesive body and then assembled together with the adhesive body and the overlay. The residual heat in the pre-heated wheel can be sufficient to cause the adhesive body to activate, thereby bonding the overlay to the wheel. In this embodiment, the adhesive body can be pre-attached to the overlay, thereby reducing the assembly time required when forming the sandwich structure wheel/adhesive body/overlay.

Suitable foamable materials useful in constructing adhesive bodies suitable for use in the present invention are also available commercially, such as, for example, the TEROPHON, TEROCORE and ORB NV products sold by Henkel AG & Co. KGaA and its affiliates.

The adhesive bodies may be shaped or formed using any suitable method, including, but not limited to, injection molding, compression molding, extrusion molding or other molding techniques. For example, a sheet comprised of a suitable material as described previously and having the thickness desired in the final adhesive body is first formed by extrusion of the material (heated to a temperature effective to soften the material, thereby permitting it to flow under pressure) through a slit die or the like, with the adhesive bodies being thereafter die cut from the sheet using a die such as a rotary die corresponding in shape to the desired shape of the adhesive body. If the adhesive body shape desired is that of a simple rectangle or ribbon, the sheet may be slit and cut after it emerges from the slit die into adhesive bodies having the desired width and length. Alternatively, granules of such suitable material may be placed into a hopper which feeds into a heated injection unit. A reciprocating screw pushes the granules through a long heating chamber, where the granules are softened to a flowable state. At the end of this chamber there is a nozzle which abuts firmly against an opening into a relatively cool, closed mold having a cavity with the same dimensions as the desired adhesive body. The heated, flowable material is forced at high pressure through the nozzle into the mold cavity. A series of clamps holds the mold halves together. Once the material has cooled to a solid state, the mold is opened and the injection molded adhesive body ejected. During such molding and shaping operations, it will generally be desirable to maintain the material being used to form the adhesive body at a temperature below which expansion of the material begins to take place (if the material is heat expandable) and curing/crosslinking of the material begins to take place (if the material is heat-curable).

Where the adhesive body is laminar (multi-layer) in structure or otherwise contains regions having different compositions, techniques such as coextrusion, overmolding, comolding and lamination may be utilized to prepare the adhesive body.

Where the adhesive body is in the form of a flexible rod or other elongated relatively narrow shape, it may be convenient to manufacture a spool or reel having a long, continuous tape, rope or ribbon wound thereon and then unwind such tape, rope or ribbon from such spool or reel and cut the adhesive body to length as needed prior to or after applying it to the wheel or overlay surface.

The present invention may be readily adapted for use in cladding any type of wheel, including the various types conventionally used in vehicles such as automobiles, trucks and so forth. Generally, such wheels are metallic and may be comprised of a metal or metal alloy such as steel, aluminum alloys, magnesium alloys and the like. Composite plastic wheels may also be clad in accordance with the present invention, however. It may be desirable to treat the outboard surface of the wheel before bonding it to the inboard surface of the overlay using the adhesive body. Such pretreatment may include, for example, subjecting the surface to conversion coating (e.g., chemically reacting the surface to enhance its corrosion resistance and/or adhesiveness), placing a layer of primer or paint on the surface (to improve its corrosion resistance and/or adhesiveness), and/or cleaning the surface (to remove contaminants that might otherwise adversely affect the adhesive bond created between the wheel and the overlay). One advantage of the present invention, however, is that a decorative finish need not be put on the outboard wheel surface, since such surface will be effectively hidden by the overlay once the wheel has been clad. For example, the outboard wheel surface may be left in rough, unpolished form, thereby simplifying the wheel manufacturing process and reducing its overall costs; a rough wheel surface may actually enhance the strength of the adhesive bond formed.

The overlay (cladding) may be constructed of any desired materials and can have any desired configuration, with the materials and configuration typically being selected to provide an attractive finish to the wheel. Generally, the overlay is relatively thin (e.g., 0.5 to 5 mm) and can be comprised of plastic (e.g., polycarbonate, polycarbonate alloys, acrylonitrile-butadiene-styrene polymers, polyamides, polyurethanes, aromatic polyethers, polyesters and the like, including both thermoplastic and thermoset materials, with the overlay optionally also comprising one or more fillers, plasticizers, pigments, reinforcing agents, adhesion promoters, stabilizers, and the like) or metal (e.g., aluminum, stainless steel, chrome-plated stainless steel). Metal-plated plastics or metal-plastic laminates may also be employed. The inboard surface of the overlay may, if desired, be pretreated before being brought into contact with the adhesive body, with exemplary pretreatments including cleaning, priming, flame treatment, ozonation and the like. Such pretreatments may help to maximize the strength of the adhesive bond ultimately formed between the wheel and the overlay upon activation of the adhesive body.

As mentioned previously, the adhesive body may be initially attached to the surface of the wheel or overlay by means of a tacky surface provided on the adhesive body, such tacky surface being provided through the use of a composition in preparing the adhesive body that is inherently tacky at room temperature or by application of a layer of a tacky substance, for example a pressure sensitive adhesive, onto the non-tacky surface of an adhesive body. In another embodiment, however, the surface of the adhesive body that is to be applied to the wheel or overlay is formulated so as to function as a hot melt adhesive. That is, the adhesive body surface is warmed to a temperature effective to render it soft and tacky and then applied while still warm to the wheel or overlay surface. An adhesive bond between the adhesive body surface and the wheel or overlay surface is retained upon cooling and resolidification of the adhesive body surface. Alternatively, the wheel or overlay may be heated and the adhesive body surface applied thereto, wherein the heated wheel or overlay surface is at a temperature effective to soften the adhesive body surface, thereby forming an adhesive bond upon cooling. In still another embodiment, however, the adhesive body is retained in the desired position on the wheel or overlay surface by means of one or more mechanical fasteners such as clips, pins or retaining tabs.

Although the adhesive body may be applied to the wheel or overlay surface by automated and/or mechanized means (e.g., through the use of a programmed robotic applicator), in other embodiments such application is performed by hand.

Once the adhesive body (or multiple adhesive bodies) has (have) been applied, the wheel and the overlay are positioned relative to each other so that the outboard surface of the wheel faces the inboard surface of the overlay with the adhesive body or bodies therebetween. Generally speaking the exposed surface of the adhesive body is brought into close proximity to the surface of the other component. The surfaces may actually be in contact with each other or spaced slightly apart from each other (e.g., 0.1 to 5 mm). For example, where the adhesive body has been applied to the outboard surface of the wheel, the surface of the adhesive body facing away from such outboard surface is positioned so that it is adjacent to the inboard surface of the overlay. Typically, such positioning also includes aligning any openings or other features in the wheel and overlay as desired. It will generally be advantageous to provide some form of mechanical interlocking, permanent or temporary, that assists in holding the wheel and overlay in the desired alignment at least until the adhesive bodies are activated by heating. For example, the wheel and overlay may be temporarily held together using one or more clamps, fixing elements and/or jigs.

In one embodiment of the invention, adhesive bodies are applied to both the inboard surface of the overlay and the outboard surface of the wheel, in a staggered and/or aligned manner. That is, the outboard surface of an adhesive body applied to the wheel outboard surface may, for example, face the inboard surface of the overlay or the inboard surface of a second adhesive body that has been applied to the overlay inboard surface.

Once the desired alignment is achieved, the adhesive body is heated to a temperature effective to cause the adhesive body to join the wheel and the overlay by one or more of a) softening and flowing of the adhesive body, b) expansion (foaming) of the adhesive body, and/or c) curing/crosslinking of the adhesive body. As explained earlier, the effective temperature will vary depending upon the components selected for use in the adhesive body, but will typically be at least 50° C. or at least 100° C. but not more than 250° C. or not more than 200° C. The assembled wheel is thereafter cooled to room temperature, resulting in a secure adhesive bond between the wheel and the overlay.

The present invention has the advantage of permitting more complete control over placement of the adhesive that joins the wheel and overlay. The size, shape and position of the adhesive bodies may be varied as may be needed to achieve the desired characteristics in the assembled wheel, such characteristics including, without limitation, the strength of the adhesive bond created, sealing of the assembled wheel to limit ingress of water or other elements, sound/vibration dampening properties, aesthetic properties (e.g., avoidance of visible adhesive in the assembled wheel), and the like.

For example, the method of the present invention can be practiced such that the adhesive body (or adhesive bodies), when activated, occupies/occupy at least 10%, or at least 25%, or at least 50% or at least 75% or at least 90% of both the outboard surface of the wheel and the inboard surface of the overlay. The size and/or number of adhesive bodies may be selected such that the adhesive body or bodies, when activated, occupies or occupy no more than 20% or no more than 40% or no more than 80% of both the outboard surface of the wheel and the inboard surface of the overlay. In another embodiment, essentially all of both the wheel outboard surface and the inboard overlay surface is occupied by the activated adhesive body or bodies. The method of the present invention can also be practiced using an expandable adhesive body or plurality of adhesive bodies wherein such adhesive bodies, when activated by heating, expand to occupy at least 25% or at least 50% or at least 75% or at least 90% of the volume between the outboard surface of the wheel and the inboard surface of the overlay. In certain embodiments, however, no more than 25% or no more than 50% or no more than 75% or no more than 90% of the volume between the outboard surface of the wheel and the inboard surface of the overlay is occupied by the expanded adhesive body or bodies. In another embodiment, essentially all of the volume between the outboard surface of the wheel and the inboard surface of the overlay is occupied by the expanded adhesive body or bodies.

What is claimed is:

1. A method for attaching an overlay to a wheel, said method comprising the steps of:
a). providing a wheel having an outboard surface;
b). providing an overlay having an inboard surface;
c). applying at least one preformed, solid, dimensionally stable, heat-activatable adhesive body to at least one of the outboard surface of the wheel or the inboard surface of the overlay;
d). positioning the wheel and the overlay so that the outboard surface of the wheel faces the inboard surface of the overlay; and
e). heating the at least one adhesive body to a temperature effective to cause said at least one adhesive body to join the wheel and the overlay.

2. The method of claim 1 wherein said adhesive body is expandable.

3. The method of claim 1 wherein the surface of the adhesive body that is applied to the outboard surface of the wheel or the inboard surface of the overlay is tacky at room temperature.

4. The method of claim 3 wherein said surface of the adhesive body initially is covered by a protective film and said protective film is removed before applying the adhesive body to the outboard surface of the wheel or the inboard surface of the overlay.

5. The method of claim 1 wherein said adhesive body is applied to the outboard surface of the wheel or the inboard surface of the overlay using a separately applied adhesive layer.

6. The method of claim 5 wherein said separately applied adhesive layer is a pressure sensitive adhesive.

7. The method of claim 1 wherein said adhesive body comprises at least two layers.

8. The method of claim 1 wherein said adhesive body has been die cut from a sheet, extruded or molded.

9. The method of claim 1 wherein said adhesive body has been injection molded.

10. The method of claim 1 wherein said adhesive body is applied to the outboard surface of the wheel or the inboard surface of the overlay by warming at least the surface of said adhesive body and pressing the surface of said adhesive body against the outboard surface of the wheel or the inboard surface of the overlay.

11. The method of claim 1 wherein said adhesive body is heat curable or cross-linkable.

12. The method of claim 1 wherein said adhesive body remains thermoplastic up to a preselected temperature and becomes thermoset when heated above said preselected temperature.

13. The method of claim 1 wherein said adhesive body is sufficiently flexible at room temperature to permit said adhesive body to be closely conformed to said outboard surface of the wheel or said inboard surface of the overlay when said outboard surface or inboard surface is nonplanar and said adhesive body is initially planar.

14. The method of claim 1 wherein said adhesive body is tacky, at room temperature, on the surface which is applied to the outboard surface of the wheel or inboard surface of the overlay and non-tacky, at room temperature, on all other surfaces.

15. The method of claim 1 wherein said adhesive body is comprised of at least one thermoplastic polymer.

16. The method of claim 1 wherein said adhesive body is comprised of at least one polymer precursor and at least one heat activated curing agent capable of inducing curing of the at least one polymer precursor when said adhesive body is heated.

17. The method of claim 1 wherein said adhesive body is not supported by or attached to a carrier.

18. A clad wheel assembly comprising an overlay and a wheel, wherein said wheel has an outboard surface, said overlay has an inboard surface, and an adhesive layer joins said inboard surface of said overlay with said outboard surface of said wheel, said adhesive layer being obtained by heating at least one preformed, solid, dimensionally stable, heat-activatable adhesive body.

19. An overlay for a wheel, said overlay having at least one preformed, solid, dimensionally stable, heat-activatable adhesive body applied thereto.

20. A wheel, said wheel having at least one preformed, solid, dimensionally stable, heat-activatable adhesive body applied thereto.
